(19) United States
(12) Patent Application Publication
(10) Pub. No.: US 2016/0203532 A1
(43) Pub. Date: Jul. 14, 2016

(54) METHOD AND SYSTEM FOR PROVIDING REAL-ESTATE TRANSACTION OPPORTUNITIES

(71) Applicant: LoudLister, LLC, Pembroke Pines, FL (US)

(72) Inventors: Naveed Peerani, Pembroke Pines, FL (US); Dave Seepersad, Plantation, FL (US)

(21) Appl. No.: 14/596,811

(22) Filed: Jan. 14, 2015

(51) Int. Cl. G06Q 30/06; G06Q 40/02; G06Q 50/16

(52) U.S. Cl. CPC G06Q 30/0601; G06Q 50/16; G06Q 40/025

(57) ABSTRACT

A system for providing real-estate transaction opportunities over a distributed computer network is disclosed. The system includes an acquisition-type module resident on a server system including at least one server and configured to receive from a seller, via a seller computer, information associated with at least one acquisition-type and associating the acquisition-type with a real-estate listing associated with the seller. The server system and the seller computer are communicatively coupled over the computer network and the acquisition-type includes a business-to-business without purchase acquisition-type.

### FIELD OF THE INVENTION

The present invention relates generally to real-estate transactions, and more particularly relates to a method and a system for bringing together real estate agents, real estate brokerage firms, individual brokers, real estate professionals/agents, private property owners (residential and/or commercial), creative financing partners, strategic real-estate materials and services partners, potential purchasers, and business-to-business prospects, including individual investors, private investors, and institutional lenders, within a singular open environment.

### BACKGROUND OF THE INVENTION

The traditional business model for real-estate agents has been to list and sell or lease real-estate properties. Real-estate agents typically use a Multiple Listing Service (hereinafter “MLS”) that includes a database with a record of a real-estate property, describing the property and usually including photographs of the property (hereinafter “listing”). MLS lists real-estate properties for other real-estate agents. MLSs are typically a searchable, private, database that is used by and provided for real-estate agents to aid them in helping their client's purchase, sell, and/or lease real-estate properties. Unfortunately, MLSs and other real-estate listing databases/websites in the current art only provide for two acquisition-types, 1) sale or 2) lease. This greatly limits the opportunities available for interested parties to enter into a mutually beneficial real-estate transaction. In the aggregate, limiting MLSs and other real-estate databases/websites to offering only sale and lease acquisition-types stifles growth and prosperity in the global real-estate industry, which could otherwise flourish through more creative transaction opportunities. Additionally, use of an MLS is limited to licensed agents who are members of a real estate association, with costs for membership varying from approximately $750 and upwards. Accordingly, MLSs are not available to a multitude of other potential parties to real estate transactions, such as private property owners (residential and/or commercial), creative financing partners, strategic real-estate materials and services partners, potential purchasers, business-to-business prospects, individual investors, private investors, and institutional lenders, and the like.

Facilitating a real-estate transaction usually involves multiple parties and/or businesses, such as lenders, insurance companies, title clearance services, real-estate attorneys, inspection companies, appraisers, materials businesses, etc., with purchasers, sellers, respective real-estate agents, and lenders coordinating some or all of these disparate parties in order to complete the transaction. This is a very inefficient system. The current art does not provide a singular portal where these disparate parties can associate themselves directly with a single targeted real-estate listing creating transparency among all parties.

These real-estate related businesses typically advertise through blanket marketing, which is a type of advertising that is presented to the general public, such as an advertisement in a magazine or newspaper. Blanket marketing has the benefit of potentially reaching a wide consumer pool; however, there is no control over the reach of the advertisements. In direct contrast, targeted advertising is a type of advertising whereby advertisements are placed so as to reach consumers based on specified traits, such as demographics, psychographics, behavioral variables, such as product purchase history, and the like. Internet advertising, such as banner ads, can be presented to users based on certain specified user-traits. However, Internet advertisements do not provide direct to consumer targeted marketing, where the real-estate related businesses can select a particular real-estate listing and make an offer tailored specifically to that selected real-estate listing. A listing specific advertising has the ability to be directly more relevant than a blanket marketing piece.

It is becoming more and more difficult in the current market for potential purchasers to obtain financing for real-estate properties. Current real-estate listing websites do not include opportunities for non-traditional creative financing, or business-to-business transactions that may include a purchase transaction element and/or equity and income elements for purchasers and sellers. Crowd-sourcing websites exist. However, crowd-sourcing in the current art is limited to new ventures, not acquisition of specific real-estate inventory, each with their individual listing attributes.

Individuals wishing to acquire or participate in real-estate or business related transactions do not currently have a means for creating a comprehensive soft offer to the listing party for negotiation. The soft offer is limited to traditional sale and lease parameters and does not include other related artifacts that may lead to a successful acceptance, especially for business-to-business transactions involving multiple owner parties. The soft offer is made in separate unstructured formats and as a result cannot be evaluated concurrently and objectively without the use of additional tracking and recording.

Therefore, a need exists to overcome the problems with the prior art as discussed above.

### SUMMARY OF THE INVENTION

The invention provides a method and system for providing real-estate transaction opportunities that overcomes the hereinafore-mentioned disadvantages of the heretofore-known devices and methods of this general type.

With the foregoing and other objects in view, there is provided, in accordance with the invention, a system for providing real-estate transaction opportunities over a distributed computer network, the system including an acquisition-type module resident on a server system including at least one server and configured to receive from a seller, via a seller computer, information associated with at least one acquisition-type and associating the acquisition-type with a real-estate listing associated with the seller, the server system and the seller computer communicatively coupled over a computer network and the acquisition-type including an acquisition-type other than a purchase only or a lease acquisition-type.

In accordance with another feature, an embodiment of the present invention includes a finance module resident on the server system and configured to receive from a lender computer an offer associated with the acquisition-type and associating the lender offer with the real-estate listing, the server system and the lender computer communicatively coupled over the computer network.

In accordance with a further feature of the present invention, an embodiment of the present invention includes a business opportunities module resident on the server system and configured to receive from a business computer an offer associated with a corresponding real-estate related business and associating the real-estate related business offer with the real-estate listing, the server system and the business computer communicatively coupled over the computer network.

In accordance with a further feature of the present invention, an embodiment of the present invention further includes a materials module resident on the server system and configured to receive from a materials business computer an offer associated with a corresponding materials business and associating the materials business offer with the real-estate listing, the server system and the materials business computer communicatively coupled over the computer network.

In accordance with a further feature of the present invention, each of the lender offer, the real-estate related business offer, and the materials business offer is viewable on a display communicatively coupled to the seller computer.

In accordance with yet another feature of the present invention, the lender offer is viewable on a display communicatively coupled to the seller computer.

In accordance with another feature of the present invention, the acquisition-type includes a plurality of acquisition-types, each of the plurality of acquisition-types differing from one another and associated with the real-estate listing.

In accordance with another feature of the present invention, the acquisition-type further includes a business-to-business acquisition-type.

In accordance with yet a further feature of the present invention, the acquisition-type further includes a business-to-business with purchase acquisition-type.

In accordance with another feature of the present invention, the acquisition-type further includes an auction acquisition-type.

In accordance with the present invention, a method for providing real-estate transaction opportunities over a distributed computer network, the method including providing a server system including at least one server; the server system receiving from a seller computer a real-estate listing, the server system and the seller computer communicatively coupled over a computer network; the server system receiving from the seller computer information associated with at least one acquisition-type; and the server system associating the acquisition-type with the real-estate listing, the acquisition-type including an acquisition-type other than a purchase only or a lease acquisition-type.

In accordance with another feature, an embodiment of the present invention also includes the server system receiving from a lender computer an offer associated with the acquisition-type, the server system and the lender computer communicatively coupled over the computer network; and the server system associating the lender offer with the real-estate listing.

In accordance with yet another feature, an embodiment of the present invention includes the server system receiving from a prospect computer an offer associated with the acquisition-type and associating the prospect offer with the real-estate listing, the prospect computer associated with at least one of a potential purchaser and a potential business-to-business business partner and the server system and the prospect computer communicatively coupled over the computer network.

In accordance with a further feature of the present invention, an embodiment of the present invention includes the server system receiving from a business computer an offer associated with a corresponding real-estate related business and associating the real-estate related business offer with the real-estate listing.

In accordance with a further feature of the present invention, an embodiment of the present invention includes the server system receiving from a materials business computer an offer associated with a corresponding materials business and associating the materials business offer with the real-estate listing.

In accordance with yet another feature of the present invention, each of the lender offer, the prospect offer, the real-estate related business offer, and the materials business offer is viewable on a display communicatively coupled to the seller computer.

In accordance with yet a further feature, an embodiment of the present invention includes a portal including at least one user interface to interface with at least one user participating in a real-estate transaction over a distributed computer network, the user being at least one of a seller, a lender, a potential purchaser, a potential business-to-business business partner, a real-estate related business, and a materials business, participation in the real-estate transaction including receiving at least one user input via a user input interface. The user input includes at least one of: a real-estate listing from a seller, information from the seller associated with at least one acquisition-type, the at least one acquisition-type including an acquisition-type other than a purchase only or a lease acquisition-type, a lender offer associated with the at least one acquisition type, a prospect offer from a potential business-to-business with purchase business partner or a potential business-to-business without purchase business partner, the prospect offer associated with the acquisition-type, an offer associated with a real-estate related business, and an offer associated with a materials business. The portal further includes a real-estate transaction management portal engine coupled to the user-interface to manage the user interface and participation in the real-estate transaction by the user using the user input. The portal also includes a real-estate transaction database coupled to the real-estate transaction management portal engine and operably configured to provide the user input to the real-estate transaction management portal engine.

In accordance with another feature of the present invention, participation in the real-estate transaction further includes selectively presenting the user input via a computer display coupled to a computer on the distributed computer network to at least one of the seller, the lender, the potential business-to-business with purchase business partner, the potential business-to-business without purchase business partner, the real-estate related business, and the materials business.

Although the invention is illustrated and described herein as embodied in a method and system for providing real-estate transaction opportunities, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a block diagram of an exemplary distributed data processing network with a server system, seller computer, business-to-business (B2B) computer, lender computer, materials business computer, and real-estate related business computer in accordance with an embodiment of the present invention;

FIG. 2a is a process flow chart representing an exemplary method of providing real-estate transaction opportunities over a network in accordance with the present invention;

FIG. 2b is a continuation flow chart of the exemplary process shown in FIG. 2a, in accordance with an embodiment of the present invention;

FIG. 3 is a block diagram of an exemplary embodiment of the server system of FIG. 1 illustrating an acquisition-type module, a finance module, a business opportunities module, and a materials module operating on the server system in accordance with the present invention;

FIG. 4 is a screenshot of an exemplary software application at least partially implementing the inventive process, the screenshot depicting a commercial listing search screen in accordance with an embodiment of the present invention;

FIG. 5 is a screenshot from the exemplary software application of FIG. 4 depicting a commercial listing advanced search screen in accordance with an embodiment of the present invention;

FIG. 6 is a screenshot from the exemplary software application of FIG. 4 depicting a business listing search screen in accordance with an embodiment of the present invention;

FIG. 7 is a screenshot from the exemplary software application of FIG. 4 depicting a business listing advanced search screen in accordance with an embodiment of the present invention;

FIG. 8 is a screenshot from the exemplary software application of FIG. 4 depicting a corporate franchise search screen in accordance with an embodiment of the present invention;

FIG. 9 is a screenshot from the exemplary software application of FIG. 4 depicting a corporate franchise advanced search screen in accordance with an embodiment of the present invention;

FIG. 10 is a screenshot from the exemplary software application of FIG. 4 depicting a residential listing search screen in accordance with an embodiment of the present invention;

FIG. 11 is a screenshot from the exemplary software application of FIG. 4 depicting a residential listing advanced search screen in accordance with an embodiment of the present invention;

FIG. 12 is a screenshot from the exemplary software application of FIG. 4 depicting an auction listing search screen in accordance with an embodiment of the present invention;

FIG. 13 is a screenshot from the exemplary software application of FIG. 4 depicting an auction advanced search screen in accordance with an embodiment of the present invention;

FIG. 14 is a screenshot from the exemplary software application of FIG. 4 depicting a user interface displaying a plurality of acquisition-types for a single commercial listing in accordance with an embodiment of the present invention;

FIG. 15 is a screenshot from the exemplary software application of FIG. 4 depicting a portion of the user interface of FIG. 14, showing a purchase only acquisition-type, in accordance with an embodiment of the present invention;

FIG. 16 is a screenshot from the exemplary software application of FIG. 4 depicting a portion of the user interface of FIG. 14, showing a B2B only acquisition-type, in accordance with an embodiment of the present invention:

FIG. 17 is a screenshot from the exemplary software application of FIG. 4 depicting a portion of the user interface of FIG. 14, showing a purchase with B2B only acquisition-type, in accordance with an embodiment of the present invention;

FIG. 18 is a screenshot from the exemplary software application of FIG. 4 depicting a user interface operable to receive a soft offer from a prospect for the purchase only acquisition-type in accordance with an embodiment of the present invention;

FIG. 19 is a screenshot from the exemplary software application of FIG. 4 depicting a user interface operable to receive a soft offer from a prospect for the B2B only acquisition-type in accordance with an embodiment of the present invention;

FIG. 20 is a screenshot from the exemplary software application of FIG. 4 depicting a user interface operable to receive a soft offer from a prospect for the purchase with B2B only acquisition-type in accordance with an embodiment of the present invention;

FIG. 21 is a screenshot from the exemplary software application of FIG. 4 depicting a user interface operable to allow a real estate agent to view information associated with each listing associated with the real estate agent's account;

FIG. 22 is a block diagram of a data processing system that may be implemented as a network device, such as any one of the computers or the server system shown in FIG. 2, in accordance with an embodiment of the present invention; and

FIG. 23 is a block diagram of another exemplary system in accordance with an embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient system and method for bringing together numerous parties and professionals in the real estate industry for engaging in efficient and transparent collaborative efforts to complete a variety of real estate transactions. Embodiments of the invention provide an inventive acquisition-type module, a finance module, a business opportunities module, and a materials module, operating on a server system, allowing lending partners, prospects, materials businesses, and other real-estate related businesses to target a particular listing for offering various real-estate transaction related services. In addition, embodiments of the invention provide inventive acquisition-types, including not merely lease and sale acquisition-types, but business-to-business acquisition-types with or without a purchase component.

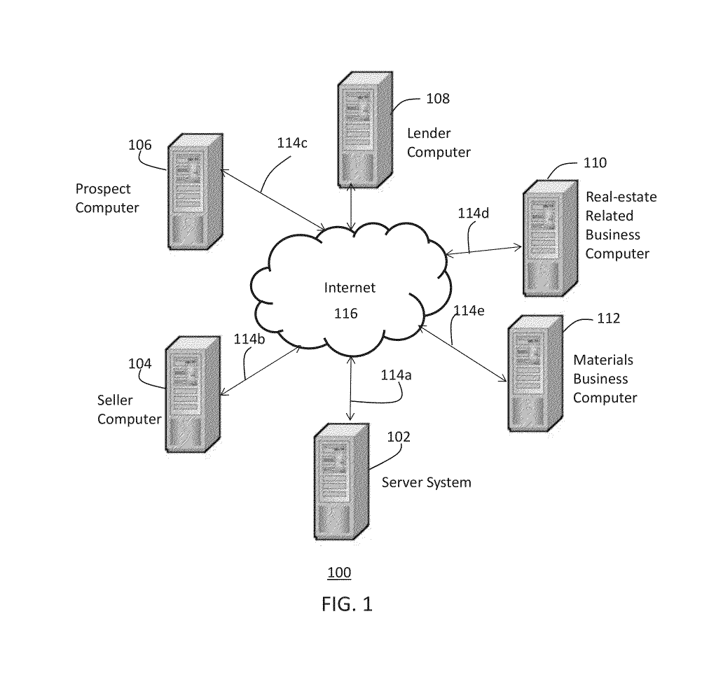

Referring now to FIG. 1, one embodiment of the present invention is shown in a schematic view. FIG. 1 shows several advantageous features of the present invention, but, as will be described below, the invention can be provided in several shapes, sizes, combinations of features and components, and varying numbers and functions of the components. The first example of a network 100 of a data processing system in which the present invention may be implemented, as shown in FIG. 1, includes a server system 102, a seller computer 104, a prospect computer 106, a lender computer 108, a real-estate related business computer 110, and a materials business computer 112, all communicatively coupled to form the network 100 through, for example, the Internet 116, via communication links 114a-e. The communication links 114a-e are the medium used to provide communications links between various devices and computers connected together within the network 100. The connections 114a-n may be wired or wireless connections. A few exemplary wired connections are cable, phone line, and fiber optic. Exemplary wireless connections include radio frequency (RF) and infrared radiation (IR) transmission. Many other wired and wireless connections are known in the art and can be used with the present invention.

In the depicted example, the network 100 can include the Internet 116, which represents a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, the network 100 also may be implemented as a number of different types of networks, such as for example, an Intranet, a local area network (LAN), or a wide area network (WAN). FIG. 1 is intended as an example, and not as an architectural limitation for the present invention.

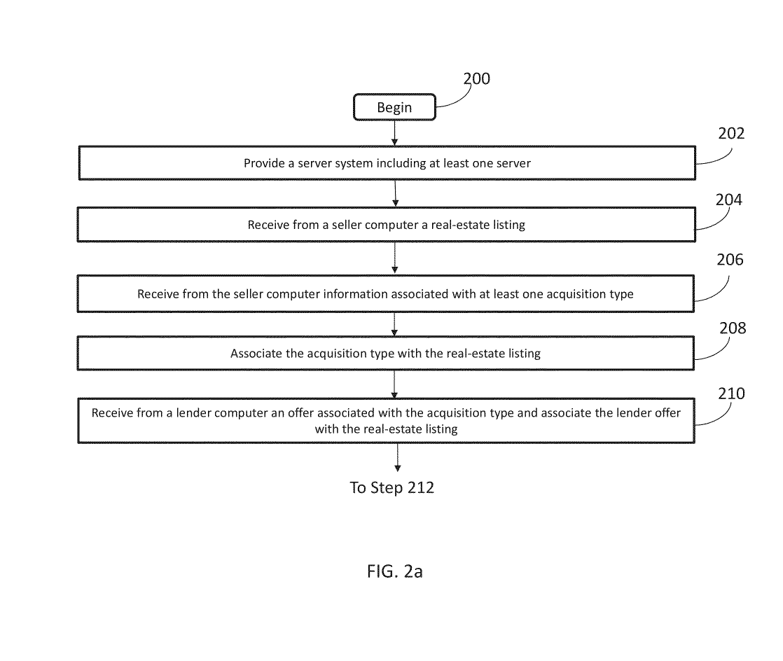

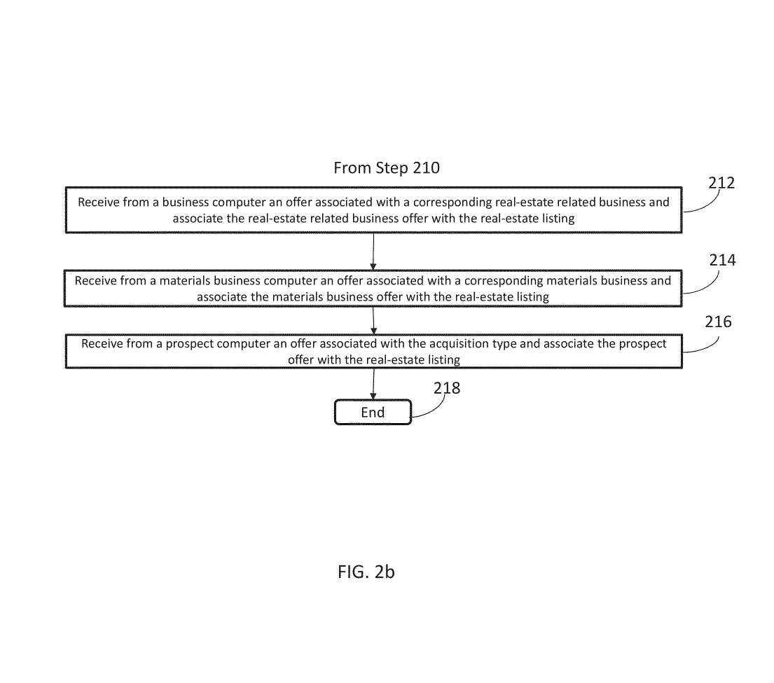

FIGS. 1 and 3 through 22 will be described in conjunction with the process flow chart of FIGS. 2a-2b. The process of FIGS. 2a-2b begins at step 200 and moves directly to step 202, where the server system 102 is provided, the server system 102 including at least one server.

In one embodiment, the server system 102 is formed as a single computer operating as a server, accepting requests from client terminals/computers and sending responses, accordingly. In another embodiment, the server system 102 is formed as a plurality of networked computers, together operating as a server, such as, for example, a cloud network. In other embodiments, the server system 102 can be formed in other configurations.

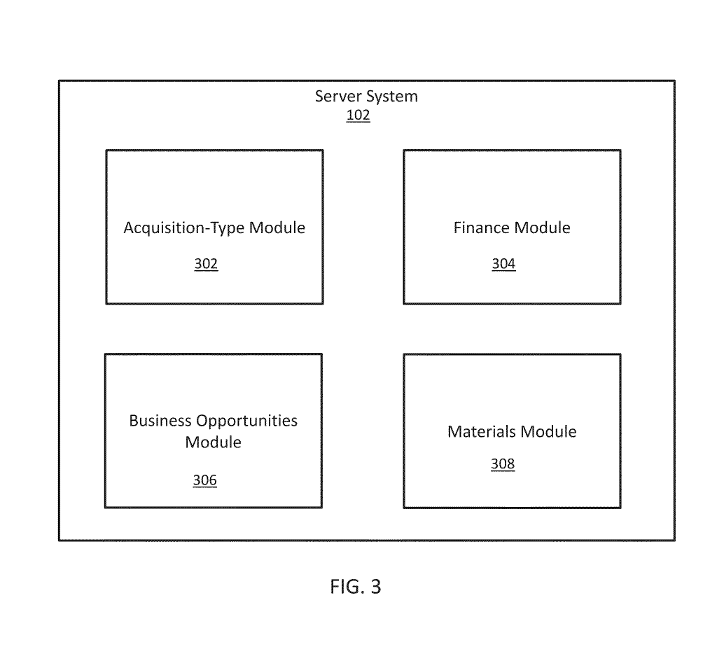

Referring primarily to FIG. 3, in one embodiment, the server system 102 includes an acquisition-type module 302, a finance module 304, a business opportunities module 306, and a materials module 308. Each of the modules 302, 304, 306, 308 may reside on the server system 102. As used herein, the term “module” is intended to indicate any portion of software code, software application, or computer program including a continuous or discontinuous set of computer instructions executable by a processor to perform one or more of the features described herein. The acquisition-type module 302 controls and/or manages the various acquisition-types that are presented to prospects. As used herein, the term “acquisition-type” is intended to indicate a method of buying or obtaining a real-estate property, a business, or other valuable asset. The finance module 304 controls and/or manages lender offers received on each listing. The business opportunities module 306 controls and/or manages business opportunities offers received on each listing. The materials module 308 controls and/or manages offers from materials businesses for each listing. The inventive operation of the modules 302, 304, 306, 308 within the network 100 will be described with more detail herein below.

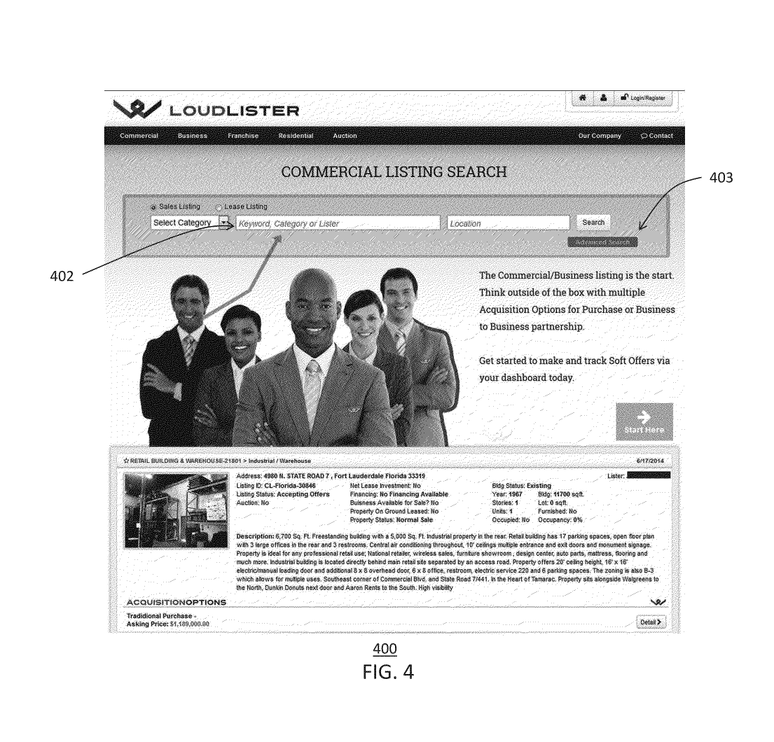

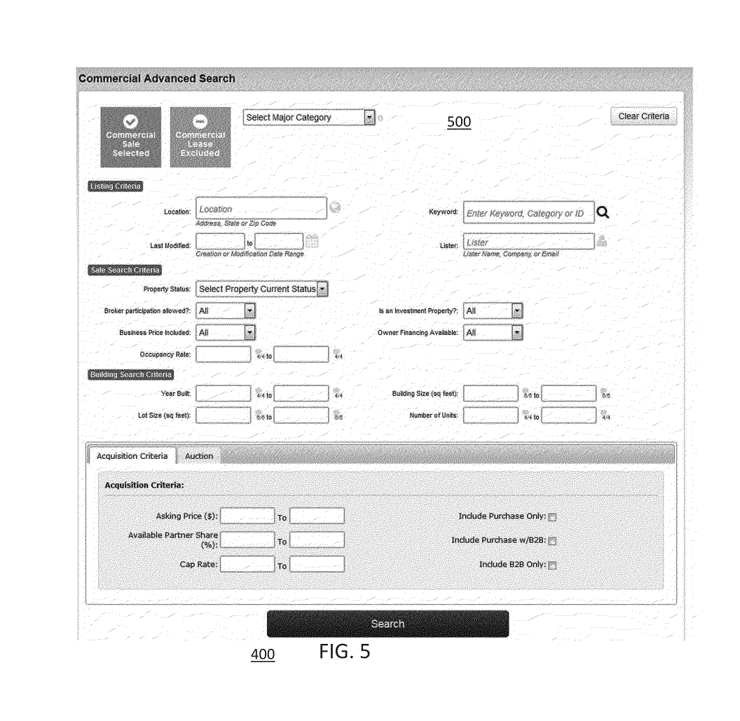

At step 204, the server system 102 receives from the seller computer 104 a real-estate listing, the server system 102 and the seller computer 104 communicatively coupled over the network 100. As used herein, the term “real-estate listing” is intended to indicate a record of a real-estate property or a business opportunity, describing the property or business opportunity and possibly including photographs of the property or business opportunity. As used herein, the term “seller computer” is intended to indicate a computer associated with a seller, a real-estate agent, or other representative of the seller representing the seller associated with the real-estate listing. Additionally, as used herein, the term “seller” is intended to indicate either the seller, the real-estate agent associated with the seller, or other representative of the seller. Referring now primarily to FIG. 4, in one embodiment, the real-estate listing can include commercial real-estate listings. The real-estate listing can include information associated with the real-estate property, such as, for example, the address, the listing identification, whether offers are currently being accepted, whether the real-estate property is available for auction, a description of the real-estate property, whether financing is available, whether the business is also available for sale, the type of sale, status regarding the building, and the like. In one embodiment, a user or prospect can search through the real-estate listings stored on the server system 102 hosting a real-estate website 400 associated with the present invention by entering search terms within a search field 402 provided on the real-estate website 400. In another embodiment, an “Advanced Search” button 403 directs the prospect to a detailed commercial listing search page 500 (FIG. 5) with generic attributes, granular listing type specific fields, and “acquisition-type” related criteria. FIG. 5 illustrates an exemplary embodiment of the detailed commercial listing search page 500. In response to submitting search terms, the real-estate website 400 will present only real-estate listings matching the search criteria entered by the user. In some embodiments, the user can then select a desired real-estate listing for review and potentially for making an offer to the seller via the real-estate website 400.

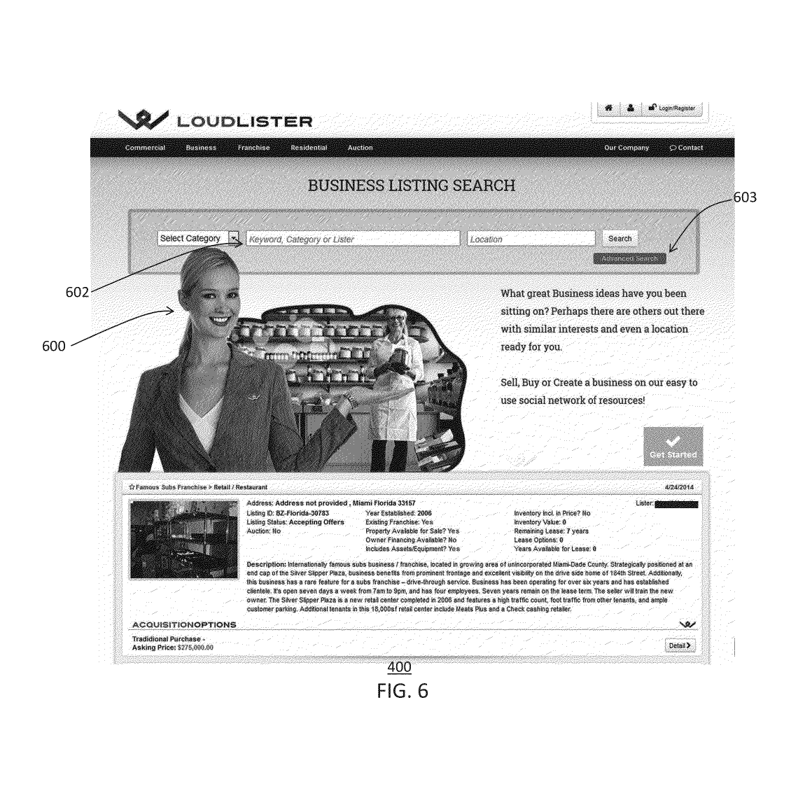

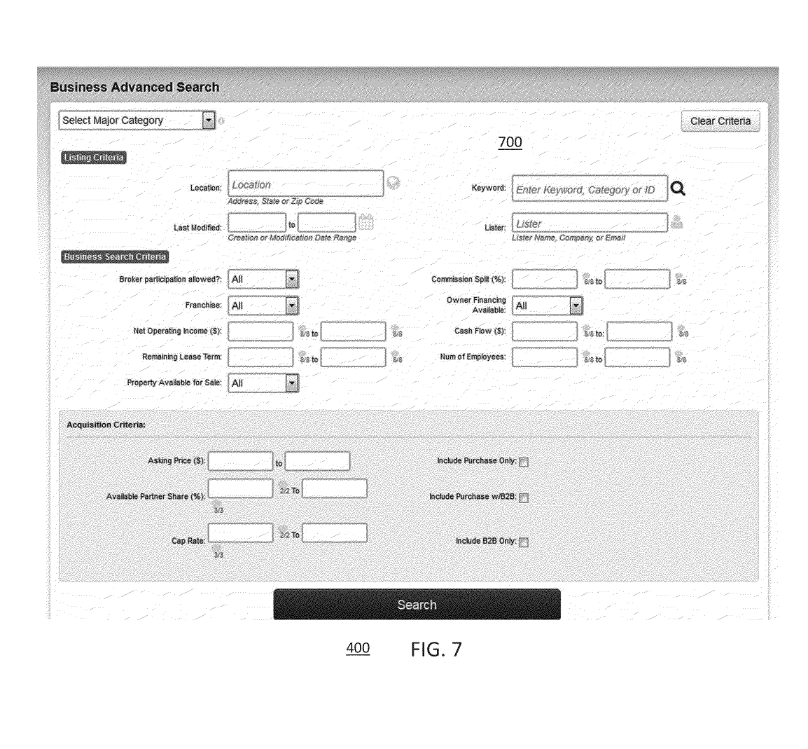

Referring now primarily to FIG. 6, in a further embodiment, the real-estate website 400 can also include a business listing search screen 600, where users can search for business listings. The business listings include the sale of a business, where the real-estate property on which the business is operating may or may not be for sale, as well. The user can search by entering search terms within a search field 602 provided on the real-estate website 400. In another embodiment, an “Advanced Search” button 603 directs the prospect to a detailed business listing search page 700 (FIG. 7) with generic attributes, granular listing type specific fields, and “acquisition-type” related criteria. FIG. 7 illustrates an exemplary embodiment of the detailed business listing search page 700. In response to submitting search terms, the real-estate website 400 will present only the business listings matching the search criteria entered by the user. In some embodiments, the user can then select a desired business listing for review and potentially for making an offer to the seller via the real-estate website 400. The business listing can include information associated with the business listing, such as, for example, the address, the listing identification, whether offers are being accepted, whether the business is available for auction, the year the business was established, whether the business is associated with an existing franchise, whether the property is also available for sale, whether the sale includes assets/equipment, whether inventory is included in the purchase price, lease options, a description of the business, and the like.

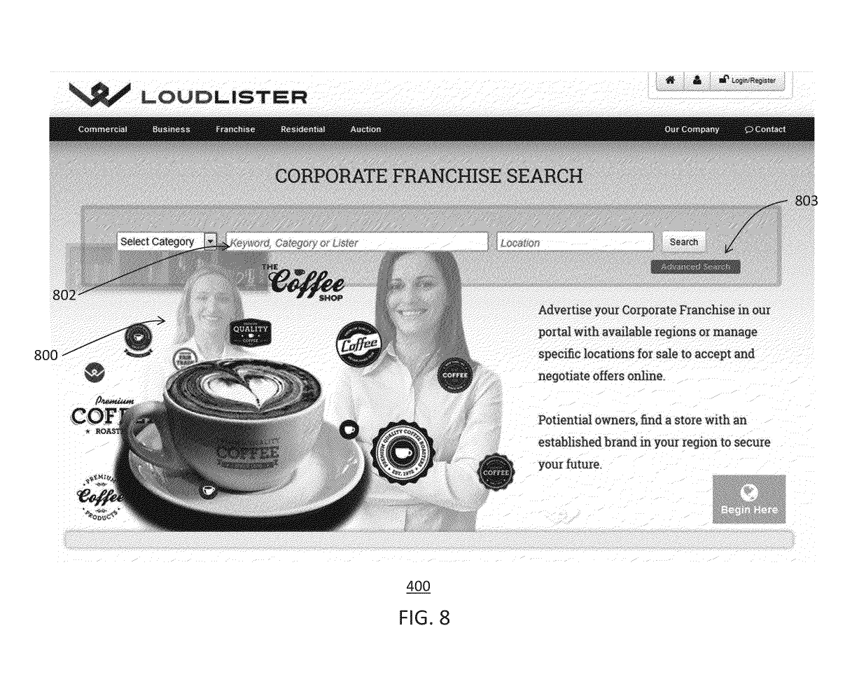

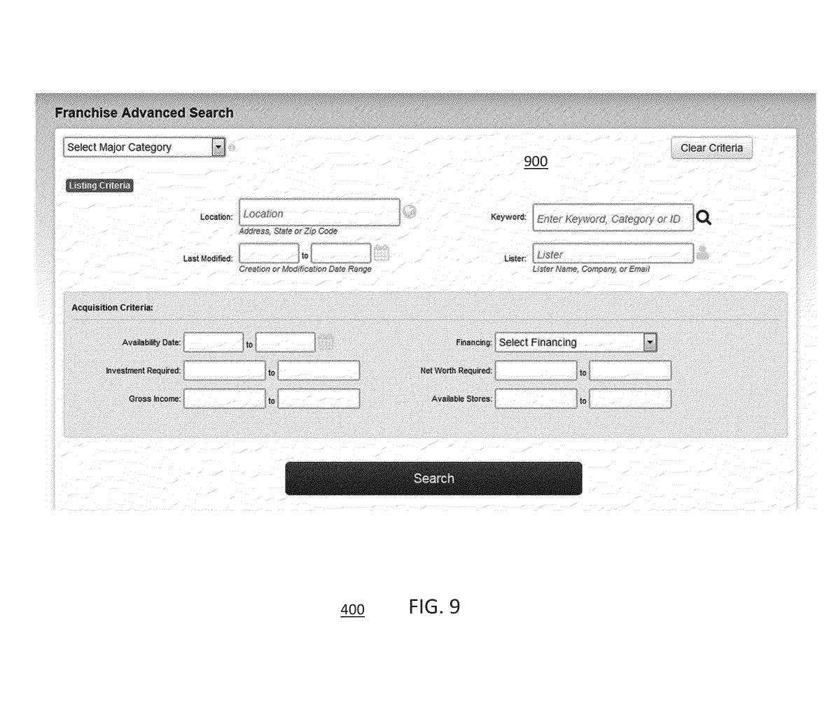

Referring now primarily to FIG. 8, in a further embodiment, the real-estate website 400 can also include a corporate franchise search screen 800, where users can search for corporate franchise opportunities. In one embodiment, the corporate franchise opportunities are listed by the corporate franchisor. In a further embodiment, lenders can submit an offer or a soft offer via the real-estate website 400 to finance a particular franchise opportunity listing. The lenders can then qualify any franchisee offers submitted via the real-estate website 400. The user can search for franchise opportunities by entering search terms within a search field 802 provided on the real-estate website 400. In another embodiment, an “Advanced Search” button 803 directs the prospect to a detailed business listing search page 900 (FIG. 9) with generic attributes, granular listing type specific fields, and “acquisition-type” related criteria. FIG. 9 illustrates an exemplary embodiment of the detailed business listing search page 900. In response to submitting search terms, the real-estate website 400 will present only the franchise opportunities matching the search criteria entered by the user. In some embodiments, the user can then select a desired franchise opportunity for review and potentially for making an offer to the seller-franchisor via the real-estate website 400.

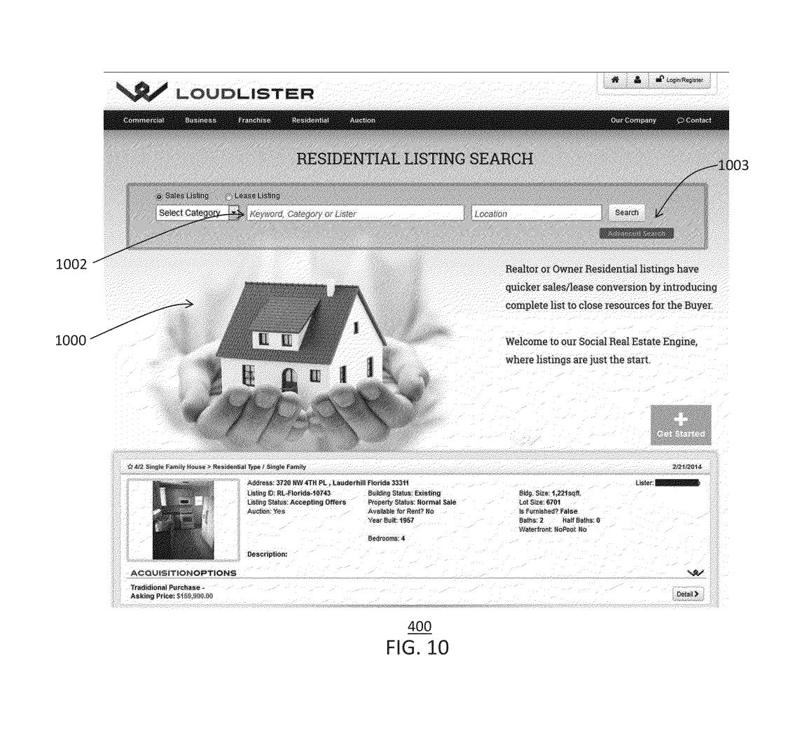

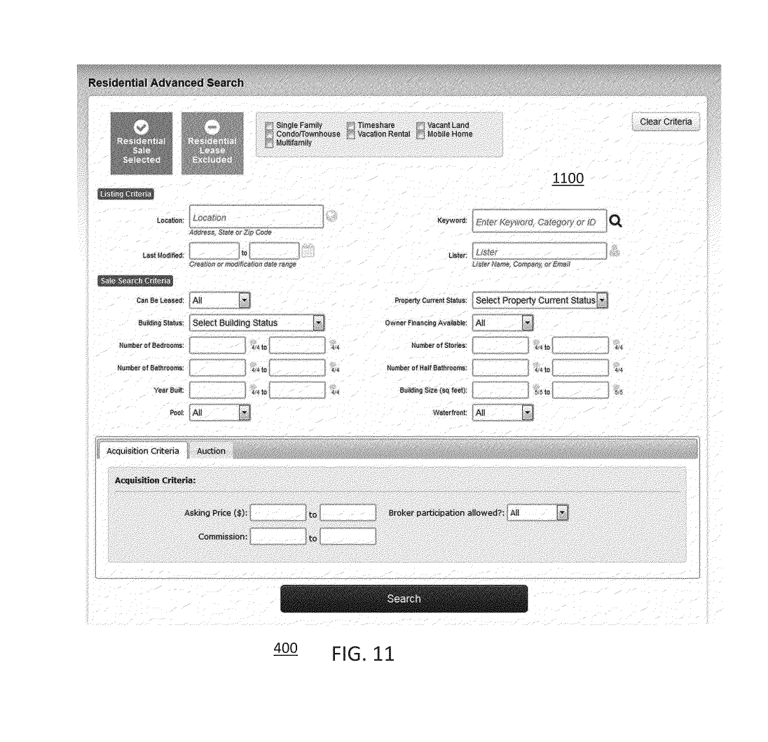

Referring now primarily to FIG. 10, in a further embodiment, the real-estate website 400 can also include a residential listing search screen 1000, where users can search for residential listings. The residential listings can include information associated with the residential property, such as, for example, the address, the listing identification, whether offers are currently being accepted, whether the real-estate property is available for auction, a description of the residential property, whether the property is available for rent, the year the property was built, the type of sale, status regarding the building, number of rooms, lot size, and the like. In one embodiment, the user or prospect can search through the residential listings stored on the server system 102 hosting the real-estate website 400 by entering search terms within a search field 1002 provided on the real-estate website 400. In another embodiment, an “Advanced Search” button 1003 directs the prospect to a detailed business listing search page 1100 (FIG. 11) with generic attributes, granular listing type specific fields, and “acquisition-type” related criteria. FIG. 11 illustrates an exemplary embodiment of the detailed business listing search page 1100. In response to submitting search terms, the real-estate website 400 will present only residential listings matching the search criteria entered by the user. In some embodiments, the user can then select a desired residential listing for review and potentially for making an offer to the seller via the real-estate website 400.

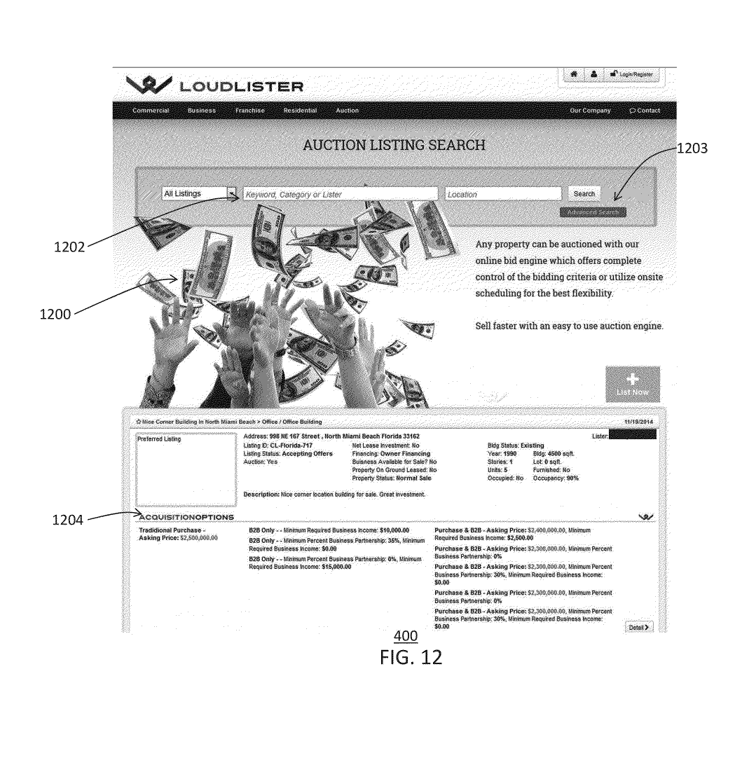

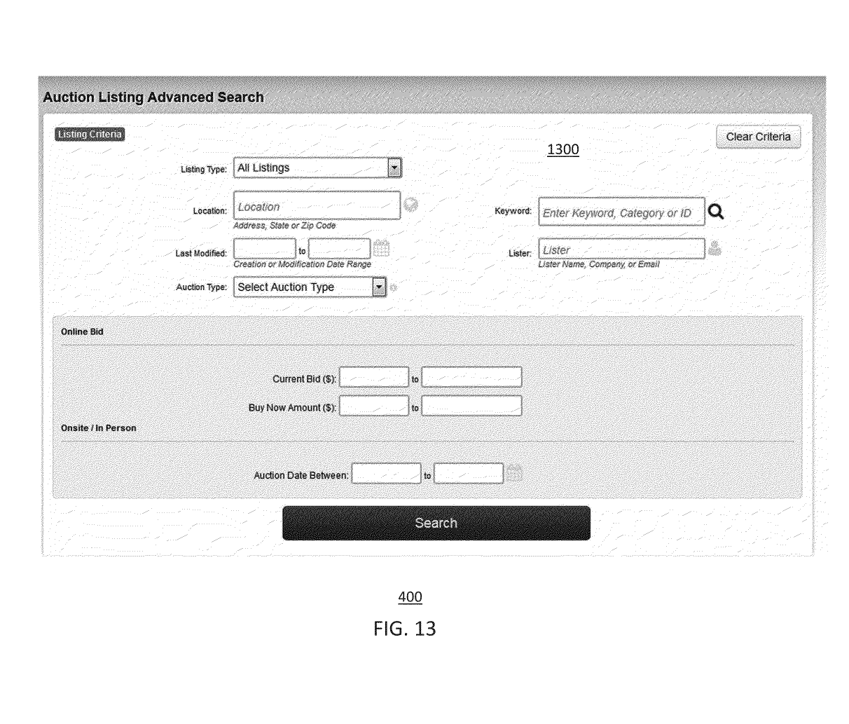

Referring now primarily to FIG. 12, in a further embodiment, the real-estate website 400 can also include an auction listing search screen 1200, where users can search for listings that are up for auction. Listings can be of any listing type that is capable of being auctioned for example Commercial, Residential, etc. The auction listings can include information associated with the property, such as, for example, the address, the listing identification, whether offers are currently being accepted, whether the real-estate property is available for auction, a description of the residential property, whether financing is available, the year the property was built, the type of sale, status regarding the building, and the like. In one embodiment, the user or prospect can search through the auction listings stored on the server system 102 hosting the real-estate website 400 by entering search terms within a search field 1202 provided on the real-estate website 400. In another embodiment, an “Advanced Search” button 1203 directs the prospect to a detailed business listing search page 1300 (FIG. 13) with generic attributes, granular listing type specific fields, and “acquisition-type” related criteria. FIG. 13 illustrates an exemplary embodiment of the detailed business listing search page 1300. In response to submitting search terms, the real-estate website 400 will present only auction listings matching the search criteria entered by the user. In some embodiments, the user can then select a desired auction listing for review and potentially for making an offer to the seller via the real-estate website 400. Each auction listing can include a plurality of acquisition options 1204 that bidders can bid on, including traditional purchase options, business-to-business (“B2B”) only options, purchase with B2B options, and the like, with varying terms for asking price, income, and partnership.

The specificity of the types of listings can be changed over time and include additional listing types as the website 400 allows. The generic listing attributes will continue to prevail as a real-estate related system that is governed by location based assets, however listing specific criteria may vary from type to type as the aforementioned examples. With each possible listing type, the availability of “acquisition-types” will be contingent upon the listing asset capability for trade but will be a subset of existing “acquisition-types” as they represent the entire array of tangible values pertinent to the real estate related transfer or use. Each listing must include at least one of the possible “acquisition-types” to facilitate a trade bearing scenario.

At step 206, the acquisition-type module 302 (FIG. 3) operating on the server system 102 receives from the seller computer 104 information associated with at least one acquisition-type. In one embodiment, the acquisition-type received from the seller computer 104 includes more than one acquisition-type. In yet another embodiment, the acquisition-type received from the seller computer 104 includes a plurality of acquisition-types, each of the plurality of acquisition-types differing from one another and associated with the real-estate listing. In a further embodiment, the acquisition-type includes a sale/purchase or lease acquisition-type. In yet another embodiment, the acquisition-type includes an acquisition-type other than a purchase only or a lease acquisition-type. In another embodiment, the acquisition-type includes a B2B acquisition-type. In a further embodiment, the acquisition-type includes a B2B acquisition-type with a purchase component. In an alternative embodiment, the acquisition-type includes a B2B acquisition-type without a purchase component. In yet another embodiment, the acquisition-type includes an auction acquisition-type.

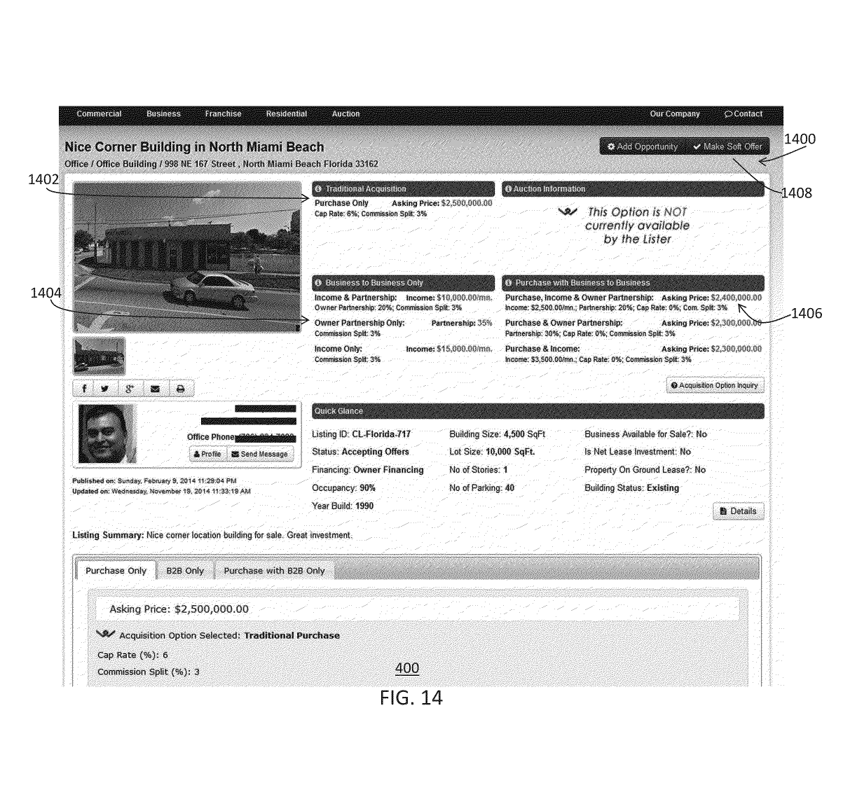

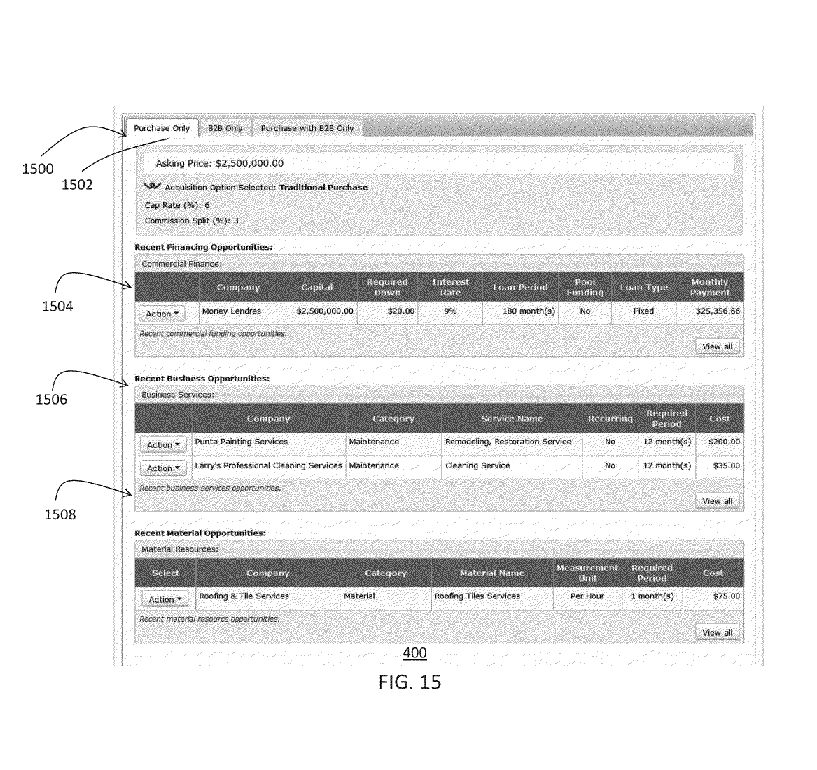

At step 208, the server system 102 associates the acquisition-types received from the seller computer 104 with the real-estate listing associated with the seller. Referring now primarily to FIG. 14, the real-estate website 400 can include a user interface 1400, displaying information associated with the real-estate listing. In one embodiment, the information can include all of the acquisition-types that are available for the real-estate listing. FIG. 14 illustrates that, for the commercial listing presented, there are three acquisition-types that are available to potential prospects, namely 1) a purchase acquisition-type 1402 for $2,500,000.00; 2) a B2B only acquisition-type 1404; and 3) a purchase with B2B acquisition-type 1406. The B2B only acquisition-type 1404 shows that there are three alternative options available to prospects: 1) income and partnership, where the seller retains 20% ownership and receives a $10,000 monthly income from the buyer/B2B partner; 2) owner partnership only, where the seller retains 35% partnership in the commercial listing, and 3) income only, where the seller receives a $15,000 monthly income from the buyer/B2B partner. In one exemplary embodiment, the purchase with B2B acquisition-type 1406 also includes three alternative options for prospects: 1) purchase, income, and owner partnership, where the seller asks for a purchase price of $2,400,000.00 for the listing (less than the purchase only asking price), but also requests a $2,500 monthly income from the buyer; 2) purchase and owner partnership, where the seller asks for a purchase price of $2,300,000.00 and retains a 30% ownership interest in the listing; and 3) purchase and income, where the seller asks for a purchase price of $2,300,000.00 and a monthly income of $3,500. As can be clearly seen, the real-estate website 400 makes creative financing and business partnership opportunities available to the general public through an easily accessible network 100 that can grow the global real-estate industry through transaction opportunities not currently available. In some embodiments, prospects can initiate a soft offer associated with the listing by clicking on a soft offer button 1408 presented on the user interface 1400. Soft offers will be discussed in more detail herein below. In one embodiment, a portion of the user interface 1400 illustrated in an upper section thereof is publicly viewable by prospects, while a lower portion of the user interface 1400, illustrated in FIGS. 15-17, with more detailed information is only viewable by the seller or the seller's real-estate agent.

Referring now primarily to FIGS. 15-17, a user interface 1500 is presented by the acquisition-type module 302 (FIG. 3), illustrating a tab for each acquisition-type available for the real-estate listing. FIG. 15 illustrates a purchase only tab section 1502 where offers associated with the purchase only acquisition-type are viewable by the seller, such as, for example, lender offers 1504, real-estate related business offers 1506, and/or materials business offers 1508.

Still referring primarily to FIG. 15, in step 210, the finance module 304 residing (or “resident”) on the server system 102 receives from the lender computer 108 an offer associated with an acquisition-type and associates the lender offer with the real-estate listing. The server system 102 and the lender computer 108 are communicatively coupled over the network 100. As used herein, the term “lender computer” is intended to indicate a computer associated with a lender. In one embodiment, the lender offers are viewable on a display communicatively coupled to the seller computer 104. In another embodiment, the user interface 1500 can display all lender offers received for each acquisition-type. In the exemplary embodiment shown in FIG. 15, the user interface 1500 illustrates a single lender for the purchase only acquisition-type. The user interface 1500 further illustrates information associated with the lender's offer, including a capital amount, a required down payment, an interest rate, a loan period, whether pool funding is allowed, a loan type, and a monthly payment amount. In one embodiment, there can be a button, a link, an icon, or the like that the seller can use to accept, reject, or modify offers. As used herein, the term “offer” is defined as an expression of one or more proposed terms, acceptance of which may, but is not required to, lead to the completion of a sale, an acquisition, or other business transaction. In one embodiment, the offer can be considered a soft offer. In another embodiment, the offer can be considered a counter-offer. Advantageously, the real-estate website 400 and associated features of the present invention allow lenders, and other vendors, to selectively market to particular types of listings through a single convenient portal/interface, that is easily accessible to the general public and requires very little marketing dollars and effort, as compared to other prior art real-estate marketing methods, such as blanket marketing and banner ads.

As used herein, the term “lender” is defined as any individual or entity that makes funds available to another with the expectation that the funds will be repaid, including fees and/or interest. The lender can be, for example, a traditional commercial lender (e.g. a bank), a private lender, a venture capitalist, an individual lender, a potential B2B partner, and the like. In one embodiment, the lender will qualify prospects/buyers and real-estate related business services, such as title clearance services, that have been associated with the real-estate listing via the server system 102.

In step 212, the business opportunities module 306 (FIG. 3) residing on the server system 102 receives from the business computer 110 an offer associated with a corresponding real-estate related business and associates the real-estate related business offer with the real-estate listing. The server system 102 and the business computer 110 are communicatively coupled over the network 100. As used herein, the term “business computer” is intended to indicate a computer associated with a real-estate related business. In one embodiment, the user interface 1500 can display all business offers received for the purchase only acquisition-type. In the exemplary embodiment, the user interface 1500 illustrates two business offers. The user interface 1500 further illustrates information associated with the business's offer, including a company name, a category of the real-estate related business, the service provided by the real-estate related business, a required time period, and a cost for the service. In one embodiment, there can be a button, a link, an icon, or the like that the seller can use to accept, reject, or modify business offers. As used herein, the term “business offer” is defined as an expression of one or more proposed terms, acceptance of which may, but is not required to, lead to the completion of a sale of a real-estate related business service or product. In one embodiment, the offer can be considered a soft offer. In another embodiment, the offer can be considered a counter-offer. Advantageously, the real-estate website 400 and associated features of the present invention allow real-estate related businesses to selectively market to particular types of listings through a single convenient portal/interface, that is easily accessible to the general public and requires very little marketing dollars and effort, as compared to other prior art real-estate marketing methods, such as blanket marketing and banner ads. As used herein, the term “real-estate related business” is defined as a business that provides a service or product used in connection with a real-estate transaction. The real-estate related business can be, for example, insurance companies, title clearance services, real-estate attorneys, inspection companies, appraisers, and the like. Business services include an inherent value for the service period, this value can be included in the opportunity in return of not only a dollar value as a purchased service but also its equivalent worth in partner equity for business-to-business “acquisition-type” or a combination of both in return for the value of the service.

In step 214, the materials module 308 (FIG. 3) residing on the server system 102 receives from the materials business computer 112 an offer associated with a corresponding materials business and associates the materials business offer with the real-estate listing. The server system 102 and the materials business computer 112 are communicatively coupled over the network 100. As used herein, the term “materials business computer” is intended to indicate a computer associated with a materials business. In one embodiment, the user interface 1500 can display all materials business offers received. In the exemplary embodiment, the user interface 1500 illustrates a single materials business offer. The user interface 1500 further illustrates information associated with the materials business's offer, including a company name, a category of the materials business, the materials provided by the materials business, a required time period, and a cost for the materials. In one embodiment, there can be a button, a link, an icon, or the like that the seller can use to accept, reject, or modify materials business offers. As used herein, the term “materials business offer” is defined as an expression of one or more proposed terms, acceptance of which may, but is not required to, lead to the completion of a sale of a material used in a real-estate or a business transaction. In one embodiment, the offer can be considered a soft offer. In another embodiment, the offer can be considered a counter-offer. Advantageously, the real-estate website 400 and associated features of the present invention allow materials businesses to selectively market to particular types of listings through a single convenient portal/interface, that is easily accessible to the general public and requires very little marketing dollars and effort, as compared to other prior art real-estate marketing methods, such as blanket marketing and banner ads. As used herein, the term “materials business” is defined as a business that provides a material used in connection with a real-estate transaction. The materials business can provide, for example, roofing materials, tiles, other flooring materials, carpet, and the like. Material resources include an inherent value for the quantity and duration of the resource provisioned. This value can be included in the opportunity in return of not only a dollar value as a purchased service but also its equivalent worth in partner equity for business-to-business “acquisition-type” or a combination of both in return for the value of the material resource.

In a preferred embodiment, each of the lender offers, the real-estate related business offers, and the materials business offers are viewable on a display communicatively coupled to the seller computer 104. In a further embodiment, the seller can have a username and a password associated with the seller's account and the seller is required to log-into his/her account in order to view all of the offers and communicate with the offerors. In another embodiment, communication between the seller and offerors, e.g., lenders, real-estate related businesses, and materials businesses, can be implemented through a messaging service provided via the real-estate website 400. In other embodiments, communication between the seller, lenders, real-estate related businesses, and materials businesses can be through other methods, such as, for example, by email. In yet another embodiment, offers are only viewable by the seller on the seller computer 104 via the seller's account and, also, on a computer associated with the particular offeror. For example, in this embodiment, the lender offer is only viewable by the seller and the lender who made the particular offer, but not by the real-estate related businesses or the materials business or any other lenders. Accordingly, the seller can have a greater negotiating position.

In one embodiment, at least one lender offer, at least one real-estate related business offer, and/or at least one materials business offer can be associated with a single offer provided as a package offer. Accordingly, the seller (or the seller's real-estate agent) can accept a single package offer that includes financing, closing, business, and materials opportunities, using a single convenient portal. In another embodiment, more than one lender offer can be combined to provide full financing for the real-estate property or business listing. Advantageously, lenders can aggregate funds to provide financing for a real-estate transaction that the lenders would otherwise not be able to provide individually as related to the specific listing.

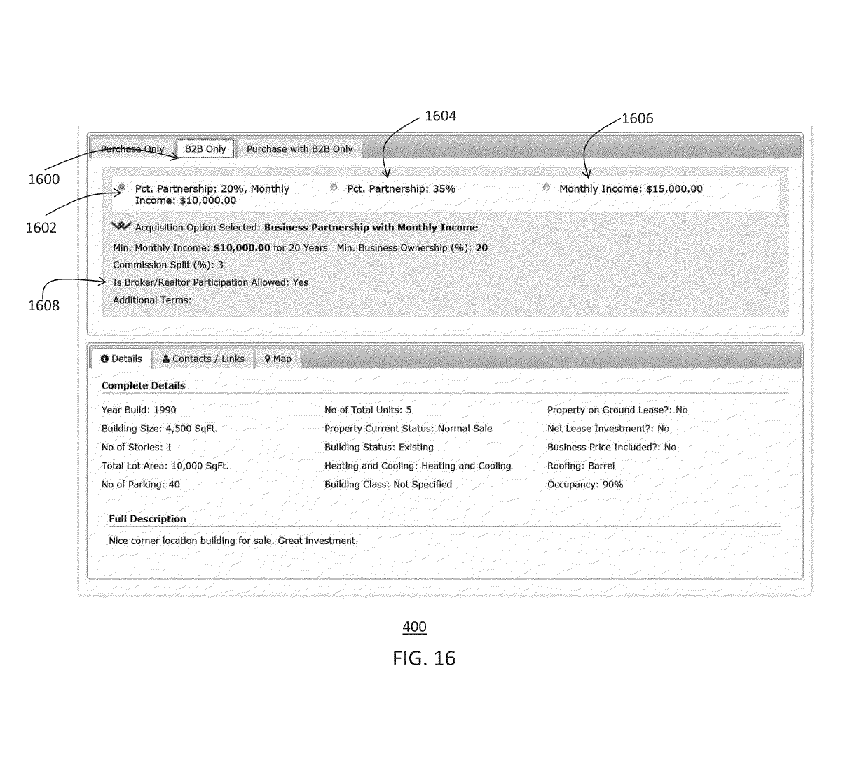

Referring now primarily to FIG. 16, there is illustrated a B2B only tab section 1600 on the real-estate website 400 where offers associated with the B2B only acquisition-type are viewable by the seller, such as, for example, a partnership and income offer 1602, a partnership only offer 1604, and/or an income only offer 1606. The partnership and income offer 1602 includes a partnership percentage, as well as a monthly income to be paid to the seller. In the exemplary embodiment, the seller retains a 20% ownership interest in the business and receives a monthly income of $10,000 for 20 years. The partnership only offer 1604 includes a percentage ownership, with no monthly income. The income only offer 1606 includes a monthly income paid to the seller for a predetermined amount of time. For example, the seller can request a $15,000.00 monthly income for a period of 20 years in exchange for the listing. In some embodiments, the purchase only, B2B only, and purchase with B2B offers can include an option 1608 allowing the seller's real-estate agent to participate in the real-estate transaction as a business partner, rather than the seller's agent. If this option 1608 is selected, in some embodiments, the seller can obtain another real-estate agent, or agree to a conflict of interest waiver.

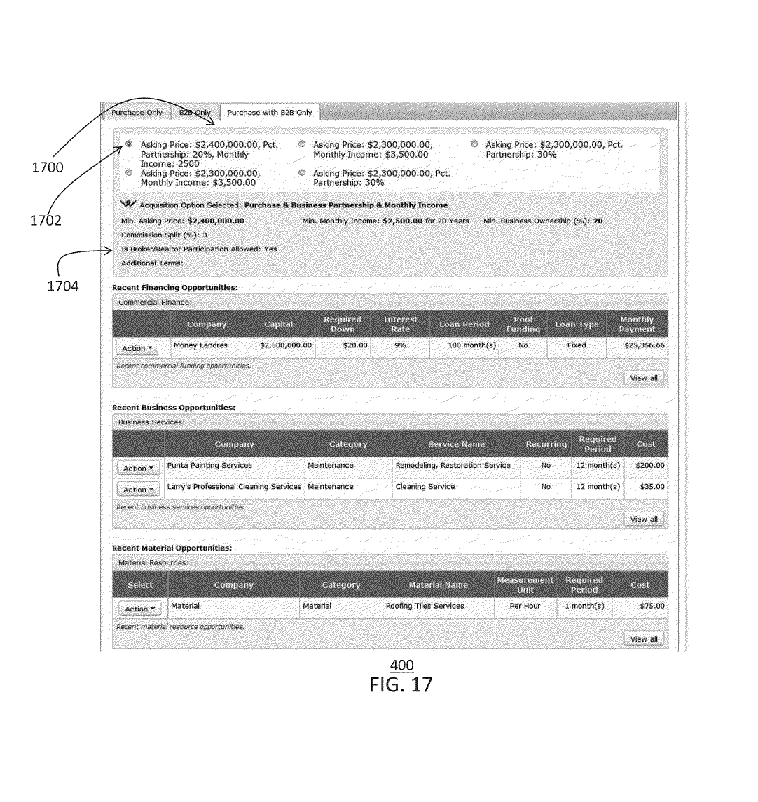

Referring now primarily to FIG. 17, there is illustrated a B2B only tab section 1700 on the real-estate website 400 where offers associated with the purchase and B2B only acquisition-type are viewable by the seller. In the exemplary embodiment shown in FIG. 17, there are 5 purchase and B2B only acquisition-type offers, each with varying terms, including an asking price, a partnership percentage, and/or a monthly income. For example, FIG. 17 illustrates that the acquisition option 1702 including an asking price of $2,400,000.00, a 20% partnership, and a $2,500 monthly income for 20 years is selected. In other embodiments, the acquisition option 1702 can include an asking price and only a monthly income, or an asking price and only a partnership percentage. The seller can include any number of unique acquisition options 1702 available to prospects. In some embodiments, the purchase only, B2B only, and purchase with B2B offers can include an option 1704 allowing the seller's real-estate agent to participate in the real-estate transaction as a business partner, rather than the seller's agent. If this option 1704 is selected, in some embodiments, the seller obtains another real-estate agent, or agrees to a conflict of interest waiver.

In step 216, the server system 102 receives from the prospect computer 106 an offer associated with the acquisition-type offered by the seller and associates the prospect offer with the real-estate listing. In one embodiment, the server system 102 and the prospect computer 106 are communicatively coupled over the network 100. As used herein, the term “prospect computer” is intended to indicate a computer associated with a prospect, where a prospect is an individual or business entity that makes at least one offer either as a potential purchaser of the real-estate listing or a potential B2B business partner. Accordingly, the prospect computer 106 is associated with a purchaser, or a potential B2B business partner. In another embodiment, the prospect can make an offer for either: 1) a purchase acquisition, 2) an auction bid, 3) a B2B only acquisition, or 4) a purchase with B2B acquisition by selecting the soft offer button/link 1408 (FIG. 14).

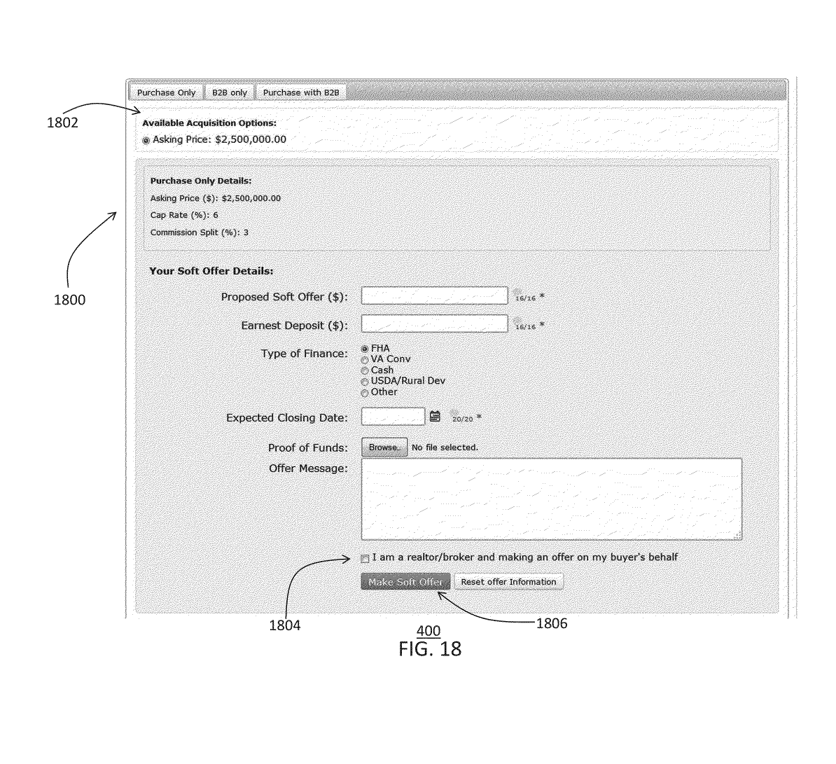

In one embodiment, in response to the prospect selecting the soft offer button 1408, the prospect is transitioned to a soft offer screen on the real-estate website 400, where the prospect can enter soft offer terms and submit the soft offer terms to the seller. An exemplary soft offer screen 1800 is illustrated in FIG. 18. In another embodiment, the soft offer screen 1800 can include a tab for each acquisition-type available for the real-estate listing. FIG. 18 illustrates a purchase only tab section 1802 where offers associated with the purchase only acquisition-type can be entered and submitted by the prospect to the seller. In one embodiment, purchase only tab section 1802 can include input fields where the prospect can enter a proposed soft offer amount, an earned deposit amount, a type of financing that will be used, an expected closing date, a proof of funds file, and a personal message associated with the offer. In another embodiment, the soft offer screen 1800 can include a checkbox 1804 indicating whether the offer is being submitted by a real-estate agent representing the prospect. In yet another embodiment, the soft offer screen 1800 can include a make soft offer button 1806 that can be selected when the prospect wants to submit or send the offer to the seller using the real-estate website 400.

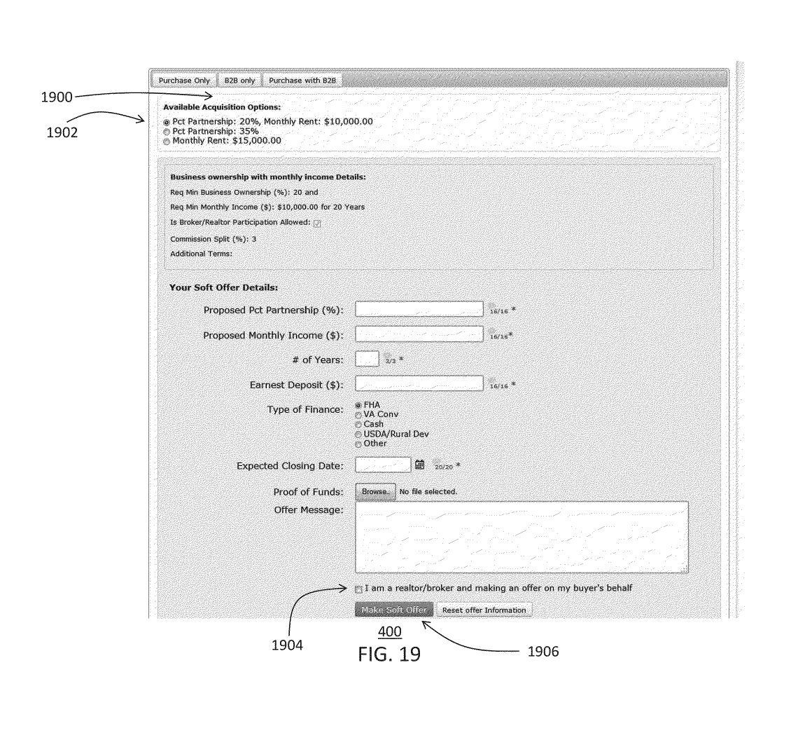

Referring to FIG. 19, an exemplary B2B only tab section 1900 is presented, where offers associated with the B2B only acquisition-type can be entered and submitted by the prospect to the seller. In one embodiment, the prospect selects one of the available acquisition options 1902 for B2B only acquisition-types provided by the seller. In the exemplary embodiment, the prospect selects the partnership and monthly income acquisition option. In a further embodiment, the B2B only tab section 1900 can include input fields where the prospect can enter a proposed partnership percentage, a proposed monthly income amount, an amount of years for the monthly income, an earned deposit amount, a type of financing that may be used, an expected closing date, a proof of funds file, and a personal message associated with the offer. In another embodiment, the B2B only tab section 1900 can include a checkbox 1904 indicating whether the offer is being submitted by a real-estate agent representing the prospect. In yet another embodiment, the B2B only tab section 1900 can include a make soft offer button 1906 that can be selected when the prospect wants to submit or send the offer to the seller using the real-estate website 400.

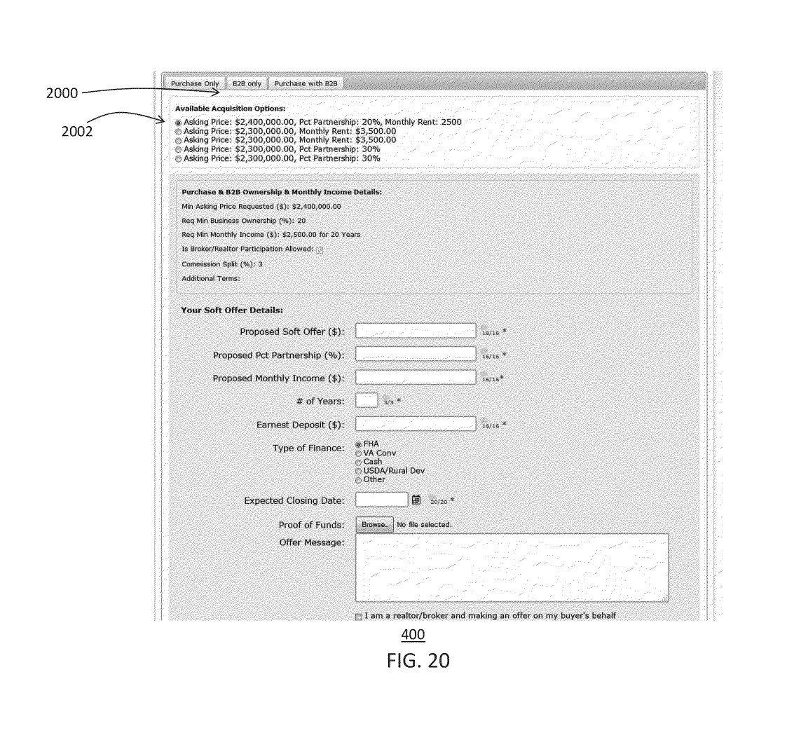

Referring to FIG. 20, an exemplary purchase with B2B only tab section 2000 is presented, where offers associated with the purchase with B2B only acquisition-type can be entered and submitted by the prospect to the seller. In one embodiment, the prospect selects one of the available acquisition options 2002 for the purchase with B2B only acquisition-types provided by the seller. In the exemplary embodiment, the prospect selects the option for a $2,400,000.00 asking price with a 20% partnership and a $2,500 monthly income. In a further embodiment, the B2B only tab section 2000 can include input fields where the prospect can enter a proposed soft offer amount, a proposed partnership percentage, a proposed monthly income amount, an amount of years for the monthly income, an earned deposit amount, a type of financing that may be used, an expected closing date, a proof of funds file, and a personal message associated with the offer.

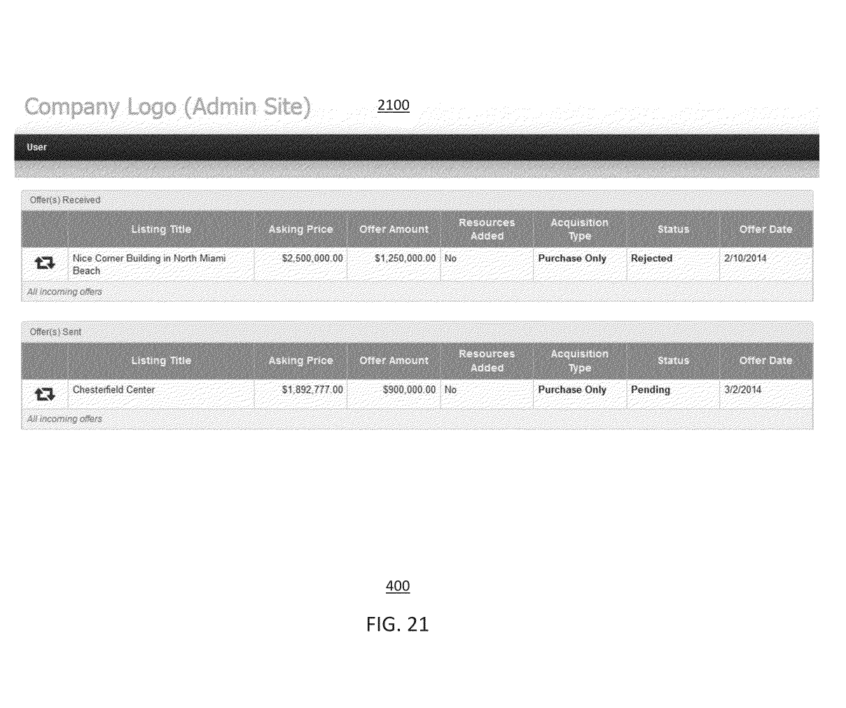

Referring to FIG. 21, the real-estate website 400 can include an offer summary screen 2100 associated with a user's account, where the user can view all offers received by the user and all offers sent by the user. The exemplary offer summary screen 2100 is provided in a table format, where each row in the table corresponds to a listing associated with an offer received or sent. The table can also include information associated with the offer for each listing, including an asking price, an offer amount, whether resources were added to the offer, an acquisition-type for the offer, whether the offer was rejected, pending, or accepted, the offer date, and the like. Advantageously, the real-estate website 400 allows seller's to receive multiple offers and reject or accept offers, while still receiving back-up offers. The process ends at step 218.

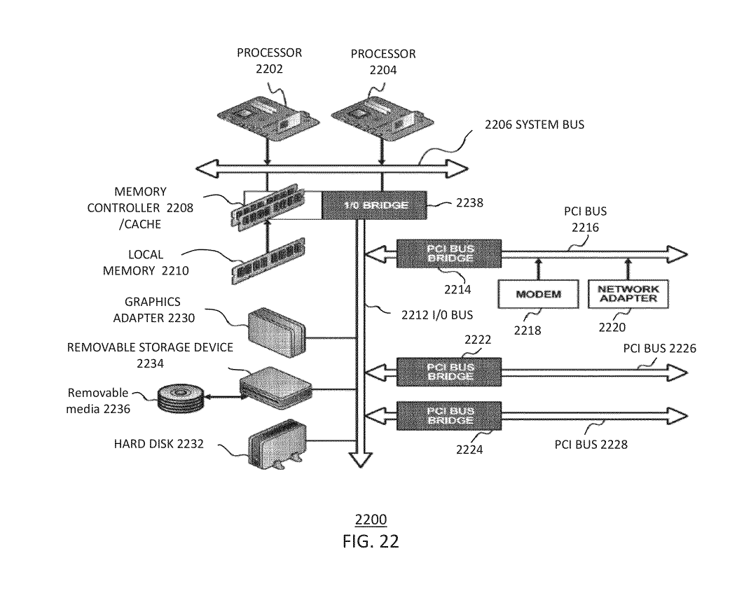

Referring to FIG. 22, a block diagram of a data processing system 2200 that may be implemented as a server within the server system 102, or implemented as a personal computer or terminal/computer associated with such servers, such as computers 104, 106, 108, 110, and 112 as shown in FIG. 1, in accordance with one embodiment of the present invention. The data processing system 2200 may be a symmetric multiprocessor (SMP) system including a plurality of processors 2202 and 2204 connected to system bus 2206. Alternatively, a single processor system may be employed. Also, connected to system bus 2206 is memory controller/cache 2208, which provides an interface to local memory 2210. An I/O bus bridge 2238 is connected to system bus 2206 and provides an interface to I/O bus 2212. The memory controller/cache 2208 and I/O bus bridge 2238 may be integrated as depicted. The processor 2202 or 2204 in conjunction with memory controller 2208 controls what data is stored in memory 2210. The processor 2202 and/or 2204 and memory controller 2208 can serve as a data counter for counting the rate of data flow to the memory 2210 or from the memory 2210 and can also count the total volume of data accessed to or from the memory 2210. The processor 2202 or 2204 can also work in conjunction with any other memory device or storage location.

Peripheral component interconnect (PCI) bus bridge 2214 connected to I/O bus 2212 provides an interface to PCI local bus 2216. A number of modems 2218, or wireless cards, may be connected to PCI bus 2216. Typical PCI bus implementations will support four PCI expansion slots or add-in connectors. PCI includes, but is not necessarily limited to, PCI-X and PCI Express components. Communications links to the network of computers in FIGS. 1 and 2 may be provided through the modem 2218 and network adapter 2220 connected to PCI local bus 2216 through add-in boards.

Additional PCI bus bridges 2222 and 2224 provide interfaces for additional PCI buses 2226 and 2228, from which additional modems or network adapters may be supported. In this manner, the data processing system 2200 allows connections to a multiple network of computers. A graphics adapter 2230 and hard disk 2232 may also be connected to I/O bus 2212 as depicted, either directly or indirectly.

Those of ordinary skill in the art will appreciate that the hardware depicted in FIG. 22 may vary. For example, other peripheral devices, such as optical disk drives and the like, also may be used in addition to or in place of the hardware depicted. The depicted example is not meant to imply architectural limitations with respect to the present invention.

The methods and features described herein can be embodied in a computer program. Computer programs (also called computer control logic) are stored in memory such as main memory 2210, removable storage drive 2234, removable media 2236, hard disk 2232, and signals. Such computer programs, when executed, enable the computer system to perform the features of the present invention as discussed herein. In particular, the computer programs, when executed, enable the processor 2202 and/or 2204 to perform the features described herein.

In this document, the terms “computer program medium,” “computer usable medium,” and “computer readable medium” are used to generally refer to media such as main memory 2210, removable storage drive 2234, removable media 2236, hard disk 2232, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired or wireless network that allows a computer to read such computer readable information.

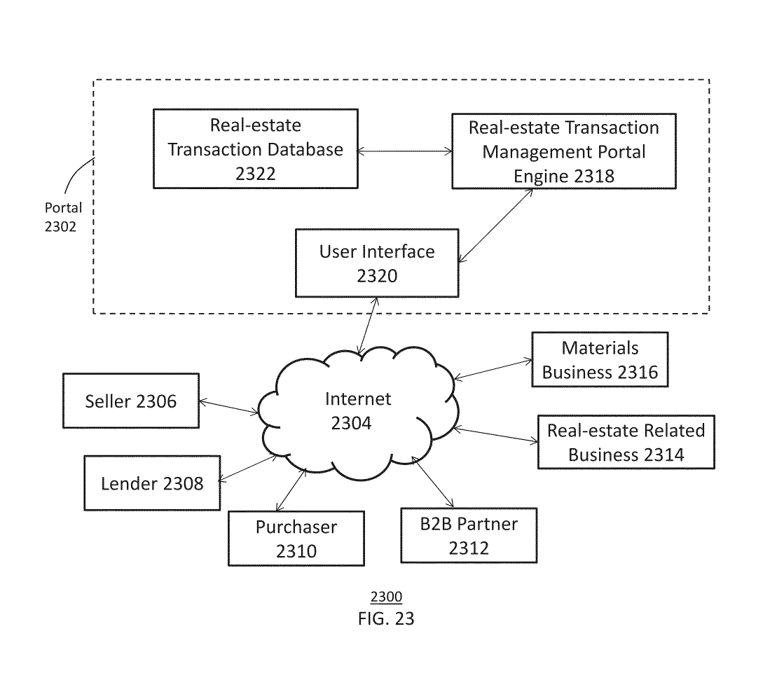

Referring now to FIG. 23, another exemplary system 2300 is illustrated according to an embodiment of the present invention. The system 2300 can include a portal 2302, a network 2304, a seller 2306, a lender 2308, a purchase 2310, a B2B business partner 2312, a real-estate related business 2314, and a materials business 2316. The portal 2302 provides functionalities for a point of access on the Internet. It provides a centralized management of real-estate transactions that may involve various entities or users, such as users represented by the seller 2306, the lender 2308, the purchaser 2310, the B2B business partner 2312, the real-estate related business 2314, and the materials business 2316, and any other third-party entities that may participate in a real-estate transaction. The portal 2302 includes a real-estate transaction management portal engine 2318, a user interface 2320, and a real-estate transaction database 2322. The user interface 2320 interfaces to a user participating in the real-estate transaction. The user may be one of the seller 2306, the lender 2308, the purchaser 2310, the B2B business partner 2312, the real-estate related business 2314, and the materials business 2316, and any other third-parties that may participate in a real-estate transaction. The real-estate transaction management portal engine 2318 is configured, set up, and operated by, for example, an administrator of a real-estate management entity that provides the portal 2302 to users on the Internet. The real-estate transaction management portal engine 2318 manages participation in the real-estate transaction by users using user input. The engine 2318 is part of the portal 2302. The engine 2318 may include a number of tools to configure, set up, and operate a portal. It may include a number of portlets customized for various users. It may include specialized processing subsystems or engines to process rules or obtain information related to the users participating in the real-estate transaction administered by the portal 2302. The engine 2318 is coupled to the user interface 2320 to manage the user interface 2320 and participation in the real-estate transaction by the users using the user input. The engine 2318 provides one or more interfaces to each of the users, i.e. the seller 2306, the lender 2308, the purchaser 2310, the B2B business partner 2312, the real-estate related business 2314, and the materials business 2316, and any other third-parties that may participate in a real-estate transaction. Each of the one or more interfaces provides accessibility to the portal 2302 by the users via the network 2300. In one embodiment, participation in the real-estate transaction further includes selectively presenting the user input via a computer display coupled a computer coupled to the network 2300. The user input can be presented to each of the users, i.e. the seller 2306, the lender 2308, the purchaser 2310, the B2B business partner 2312, the real-estate related business 2314, and the materials business 2316, and any other third-parties that may participate in a real-estate transaction. In one embodiment, the engine 2318 includes executing business rules relating to which user input can be presented to which user. For example, in one embodiment, the seller 2306 can be presented with information associated with B2B offers; however, real-estate related businesses 2314 and materials businesses 2316 can be precluded from viewing particulars of such information, such as details of a soft offer. This feature can protect the privacy of users and ensure that only relevant user input is shared to each other user in the real-estate transaction.

The real-estate transaction database 2322 is a centralized database that receives user input, stores the user input in non-volatile memory, and allows the engine 2318 to access stored user input. The database 2322 is coupled to the engine 2318 and is operably configured to provide the user input to the engine 2318 upon request. The database 2322 may be a single database, or include more than one database.

A novel and efficient system and method of bringing together numerous potential business partners and real-estate professionals has been disclosed that allows professionals within the real-estate industry and potential prospects to engage in efficient, creative transactions within an easily accessible forum that facilitates such efficient, diverse transactions over a distributed network. Embodiments of the invention provide an inventive website/portal that allows sellers to offer a multitude of acquisition-types not previously available on real-estate listing websites, including business-to-business acquisition-types with or without a purchase component. In addition, embodiments of the invention provide a system that allows various types of lending partners, materials businesses, and other real-estate related businesses to target market to a particular listing for offering various real-estate transaction related services within a single, convenient portal.

What is claimed is:

1. A system for providing real-estate transaction opportunities over a distributed computer network, the system comprising:
an acquisition-type module resident on a server system including at least one server and configured to receive from a seller, via a seller computer, information associated with at least one acquisition-type and associating the at least one acquisition-type with a real-estate listing associated with the seller, the server system and the seller computer communicatively coupled over a computer network and the at least one acquisition-type including an acquisition-type other than a purchase only or a lease acquisition-type.

2. The system in accordance with claim 1, further comprising:
a finance module resident on the server system and configured to receive from a lender computer an offer associated with the at least one acquisition-type and associating the lender offer with the real-estate listing, the server system and the lender computer communicatively coupled over the computer network.

3. The system in accordance with claim 2, further comprising:
a business opportunities module resident on the server system and configured to receive from a business computer an offer associated with a corresponding real-estate related business and associating the real-estate related business offer with the real-estate listing, the server system and the business computer communicatively coupled over the computer network.

4. The system in accordance with claim 3, further comprising:
a materials module resident on the server system and configured to receive from a materials business computer an offer associated with a corresponding materials business and associating the materials business offer with the real-estate listing, the server system and the materials business computer communicatively coupled over the computer network.

5. The system in accordance with claim 4, wherein:
each of the lender offer, the real-estate related business offer, and the materials business offer is viewable on a display communicatively coupled to the seller computer.

6. The system in accordance with claim 2, wherein:
the lender offer is viewable on a display communicatively coupled to the seller computer.

7. The system in accordance with claim 1, wherein:
the at least one acquisition-type includes a plurality of acquisition-types, each of the plurality of acquisition-types differing from one another and associated with the real-estate listing.

8. The system in accordance with claim 1, wherein:
the at least one acquisition-type further includes a business-to-business without purchase acquisition-type.

9. The system in accordance with claim 1, wherein:
the at least one acquisition-type further includes a business-to-business with purchase acquisition-type.

10. The system in accordance with claim 1, wherein:
the at least one acquisition-type further includes an auction acquisition-type.

11. A method of providing real-estate transaction opportunities over a distributed computer network, the method comprising:
providing a server system including at least one server;
the server system receiving from a seller computer a real-estate listing, the server system and the seller computer communicatively coupled over a computer network;
the server system receiving from the seller computer information associated with at least one acquisition-type; and
the server system associating the at least one acquisition-type with the real-estate listing, the at least one acquisition-type including an acquisition-type other than a purchase only or a lease acquisition-type.

12. The method in accordance with claim 11, further comprising:
the server system receiving from a lender computer an offer associated with the at least one acquisition-type, the server system and the lender computer communicatively coupled over the computer network; and
the server system associating the lender offer with the real-estate listing.

13. The method in accordance with claim 12, further comprising:
the server system receiving from a prospect computer an offer associated with the at least one acquisition-type and associating the prospect offer with the real-estate listing, the prospect computer associated with at least one of a potential business-to-business with purchase business partner and a potential business-to-business without purchase business partner and the server system and the prospect computer communicatively coupled over the computer network.

14. The method in accordance with claim 13, further comprising:
the server system receiving from a business computer an offer associated with a corresponding real-estate related business and associating the real-estate related business offer with the real-estate listing.

15. The method in accordance with claim 14, further comprising:
the server system receiving from a materials business computer an offer associated with a corresponding materials business and associating the materials business offer with the real-estate listing.

16. The method in accordance with claim 15, wherein:
each of the lender offer, the prospect offer, the real-estate related business offer, and the materials business offer is viewable on a display communicatively coupled to the seller computer.

17. A portal comprising:
at least one user interface to interface with at least one user participating in a real-estate transaction over a distributed computer network, the at least one user being at least one of a seller, a lender, a potential purchaser, a potential business-to-business business partner, a real-estate related business, and a materials business, participation in the real-estate transaction including receiving at least one user input via a user input interface, the at least one user input including at least one of:
a real-estate listing from a seller,
information from the seller associated with at least one acquisition-type, the at least one acquisition-type including an acquisition-type other than a purchase only or a lease acquisition-type,
a lender offer associated with the at least one acquisition type,
a prospect offer from a potential business-to-business with purchase business partner or a potential business-to-business without purchase business partner, the prospect offer associated with the at least one acquisition-type,
an offer associated with a real-estate related business, and
an offer associated with a materials business;
a real-estate transaction management portal engine coupled to the user-interface to manage the at least one user interface and participation in the real-estate transaction by the at least one user using the at least one user input; and
a real-estate transaction database coupled to the real-estate transaction management portal engine and operably configured to provide the at least one user input to the real-estate transaction management portal engine.

18. The portal in accordance with claim 17, wherein:
participation in the real-estate transaction further including selectively presenting the at least one user input via a computer display coupled to a computer on the distributed computer network to at least one of the seller, the lender, the potential business-to-business with purchase business partner, the potential business-to-business without purchase business partner, the real-estate related business, and the materials business.

19. The portal in accordance with claim 17, wherein:
the at least one acquisition-type includes a plurality of acquisition-types, each of the plurality of acquisition-types differing from one another and associated with the real-estate listing.

20. The portal in accordance with claim 17, wherein:
the at least one acquisition-type further includes at least one of:
a business-to-business without purchase acquisition-type; and
a business-to-business with purchase acquisition-type.
